(19) United States
(12) Patent Application Publication
(10) Pub. No.: US 2010/0000630 A1
(43) Pub. Date: Jan. 7, 2010

(54) WORK PIECE FEEDING AND CONVEYING DEVICE FOR A PLANING MACHINE

(76) Inventor: Bor-Yann CHUANG, Taiping City (TW)

Correspondence Address: SINORICA, LLC, 2275 Research Blvd., Suite 500, ROCKVILLE, MD, 20850, US

(21) Appl. No.: 12/168,663

(22) Filed: Jul. 7, 2008

(51) Int. Cl. B27C 1/00

(52) U.S. Cl. 144/128

(57) ABSTRACT

A work piece feeding and conveying device for a planing machine includes a foundation base, an intermediate base and an upper base. The intermediate base is assembled with a convey unit and the upper base is pivotally provided with a plane knife. A motor is installed between the convey unit and the foundation base, having its driving shaft fixed thereon with a first driving wheel and a second driving wheel. A first transmission member and a second transmission member respectively pass around the first and the second driving wheel. The first transmission member has another end passing around a knife shaft, while the second transmission member has another end going around the convey unit. Thus, the plane knife and the convey unit can respectively be driven to rotate by the first and the second transmission member separately disposed on the driving shaft of the same motor.

### BACKGROUND OF THE INVENTION

1. Field of the Invention

This invention relates to a planing machine, particularly to one provided with an improved work piece feeding and conveying device.

2. Description of the Prior Art

The work piece feeding and conveying device of a conventional planning machine, as shown in FIG. 1, includes a foundation base 1, an intermediate base 2, a convey unit 3, an upper base 4 and a transmission unit 5 combined together. The intermediate base 2 and the upper base 4 have their four corners respectively assembled with a threaded rod 6, and the upper base 4 is threadably provided with a rotary handle 7 at a preset location to drive the four threaded rods 6 to rotate for adjusting a planing distance between the upper base 4 and the intermediate base 2. The upper base 4 is further fixed with a knife shaft 8 having a planing knife 9 pivotally combined thereon and having one end extending out of one side of the upper base 4 and connected with a motor (not shown) installed on the foundation base 1 so that the planning knife 9 can be driven by the motor to rotate and carry out planing work. The knife shaft 8 has the other end extending out of another side of the upper base 4 to be connected with the transmission unit 5. The convey unit 3 is assembled on the intermediate base 2, consisting of a front spindle 3a, a rear spindle 3b and a conveyer belt 3c. The front spindle 3a is fixed at the front end of the intermediate base 2 and has one end disposed with a driven wheel 3d protruding outward. The rear spindle 3b is pivotally combined at the rear end of the intermediate base 2, able to be shifted forward and backward for a preset distance at the rear end of the intermediate base 2. The conveyer belt 3c is annularly fitted around the intermediate base 2, passing around both the front spindle 3a and the rear spindle 3b and driven to rotate by the front spindle 3a.

The transmission unit 5 of the conventional planning machine, as shown in FIG. 2, includes a first gear set 5a, a transmission shaft 5b and a second gear set 5c. The first gear set 5a is secured at one side of the upper base 4, consisting of a knife shaft gear (A), a worm (B), a guide gear (C) and a worm wheel (D). The knife shaft gear (A) is connected with the knife shaft 8 and driven to rotate by the knife shaft 8. The worm (B) has its end firmly fitted thereon with the guide gear (C) engaged with the knife shaft gear (A) for actuating the worm (B) to rotate. The worm wheel (D) is engaged with the worm (B), having its center fixedly fitted with the transmission shaft 5b for actuating the transmission shaft 5b to rotate. The transmission shaft 5b has its lower end engaged with the second gear set 5c, which contains a transmission sector gear (not shown) fitted at the Tower end of the transmission shaft 5b. The transmission sector gear has its outer side engaged with a transmission wheel (E) connected to the driven wheel 3d of the front spindle 3a by means of a chain (H). Thus, when the second gear set 5c is driven to rotate by the transmission shaft 5b, the driven wheel 3d of the front spindle 3a will be rotated simultaneously to actuate the conveyer belt 3c of the convey unit 3 to operate and convey a work piece inward from the front end of the intermediate base 2. At this time, the rough surface of the conveyer belt 3c will produce friction force for conveying the work piece from the front end to the rear end of the intermediate base 2 to be planed.

In operating, as shown in FIG. 3, the planing knife 9 of the conventional planing machine is directly driven by the motor (G) to rotate and have another end actuating the transmission unit 5 to operate and transmit power source for driving the conveying unit 3 to rotate by means of multiple gear sets of the transmission unit 5. Therefore, the whole operation of the conventional planing machine is carried out by the same motor, able to elevate power working efficiency of the motor and needless to additionally provide extra power. However, when the convey unit 3 is out of order, work piece planing will be influenced and the whole planing table will be unable to function. Although employing the same motor (G) for driving members to operate can elevate the working efficiency of the motor (G), yet when one of the interacting members is damaged, the whole operation of the conventional planning machine will be affected. In addition, transmitting rotating speed of the motor (G) by means of the transmission unit 5 may cause velocity difference.

### SUMMARY OF THE INVENTION

The objective of this invention is to offer a work piece feeding and conveying device for a planing machine, including a foundation base, an intermediate base, an upper base and a transmission unit. The intermediate base is assembled thereon with a convey unit and the upper base is pivotally provided with a planing knife. A motor is installed at a location between the convey unit and the foundation base, having its driving shaft disposed thereon with a first driving wheel and a second driving wheel. A first transmission member and a second transmission member respectively pass around the first driving wheel and the second driving wheel. The first transmission member has another end passing around a knife shaft, while the second transmission member has another end going around the convey unit.

By so designing, the planing knife and the convey unit can respectively be driven to rotate without interfering each other by the first transmission member and the second transmission member, which are separately fitted on the driving shaft of the same motor, thus enabling the planning machine to work with high efficiency. In addition, the first and the second transmission member are driven to transmit power separately not to affect the rotating speed transmitted by the motor, able to elevate processing accuracy.

### BRIEF DESCRIPTION OF DRAWINGS

This invention will be better understood by referring to the accompanying, wherein:

FIG. 1 is a side cross-sectional view of a work piece feeding and conveying device of a conventional planing machine;

FIG. 2 is an upper cross-sectional view of a first gear set of the work piece feeding and conveying device of the conventional planing machine;

FIG. 3 is a block diagram of power transmission in the interior of the work piece feeding and conveying device of the conventional planing machine;

FIG. 4 is a block diagram of power transmission in the interior of a work piece feeding and conveying device for a planing machine in the present invention;

FIG. 5 is a perspective view of the planing machine in the present invention;

FIG. 6 is a partial perspective view of the interior structure of the planing machine in the present invention;

FIG. 7 is a side cross-sectional view of the planing machine in the present invention, showing the whole interaction condition of all the components when a motor is operated;

FIG. 8 is a partial magnified rear view of the planing machine in the present invention, showing the mutually engaged gears and their interaction condition of a transmission unit; and

FIG. 9 is a partial magnified front view of the planing machine in the present invention, showing the mutually engaged gears and their interaction condition of the transmission unit.

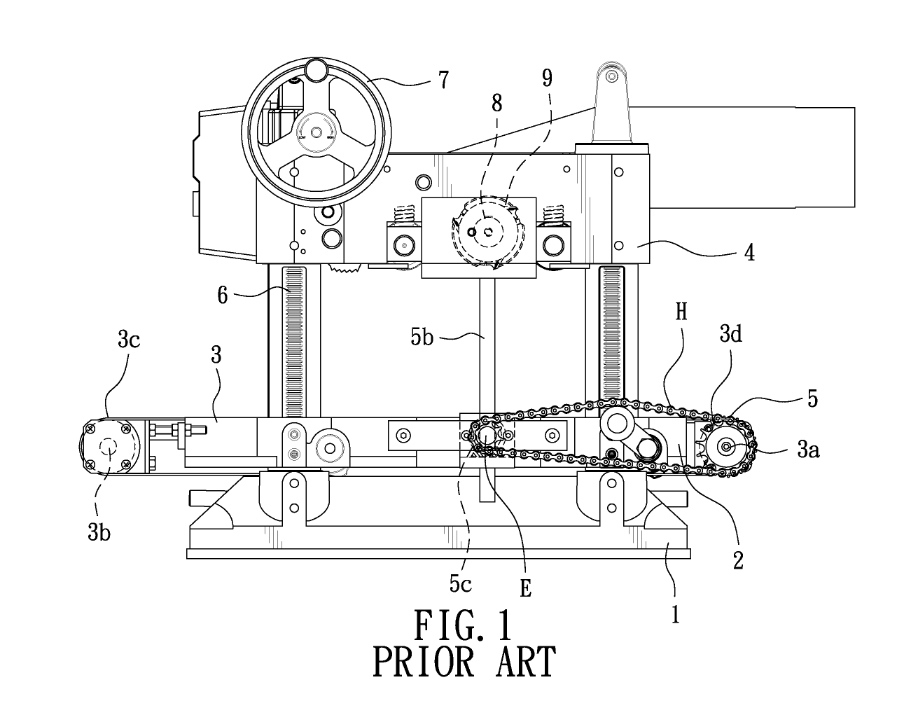

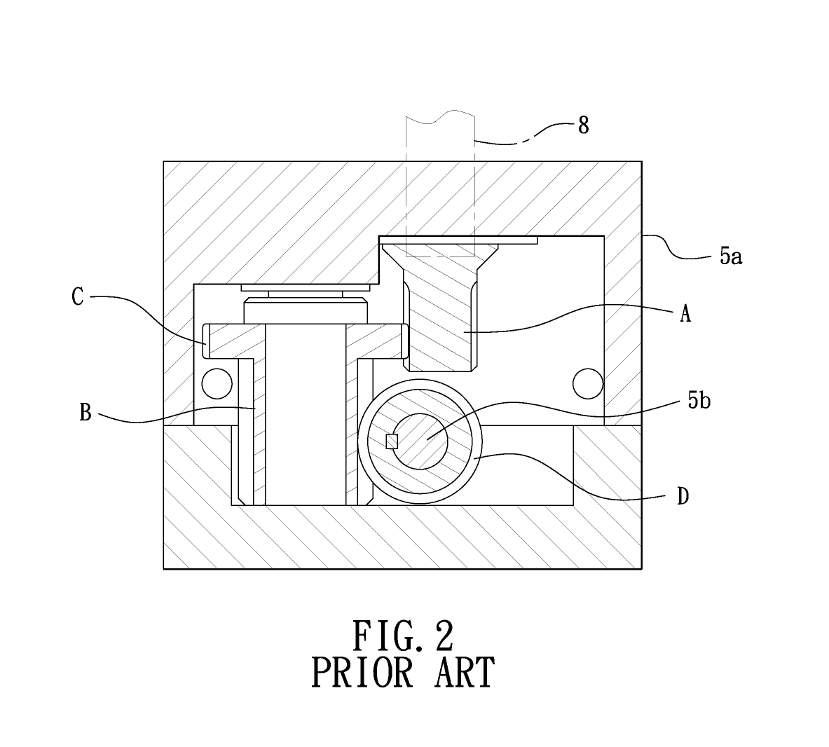

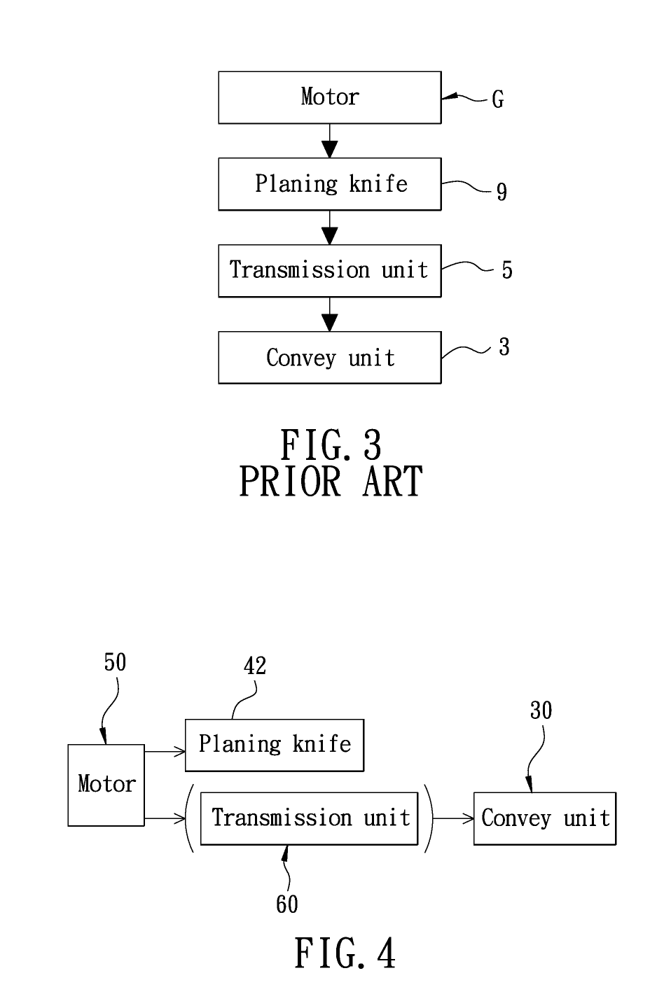

### DETAILED DESCRIPTION OF THE PREFERRED EMBODIMENT

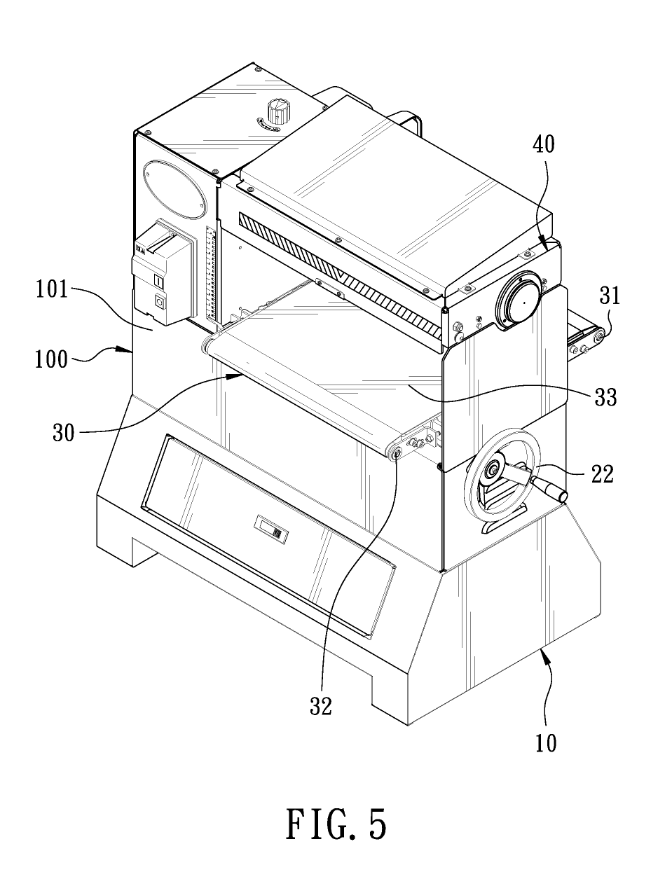

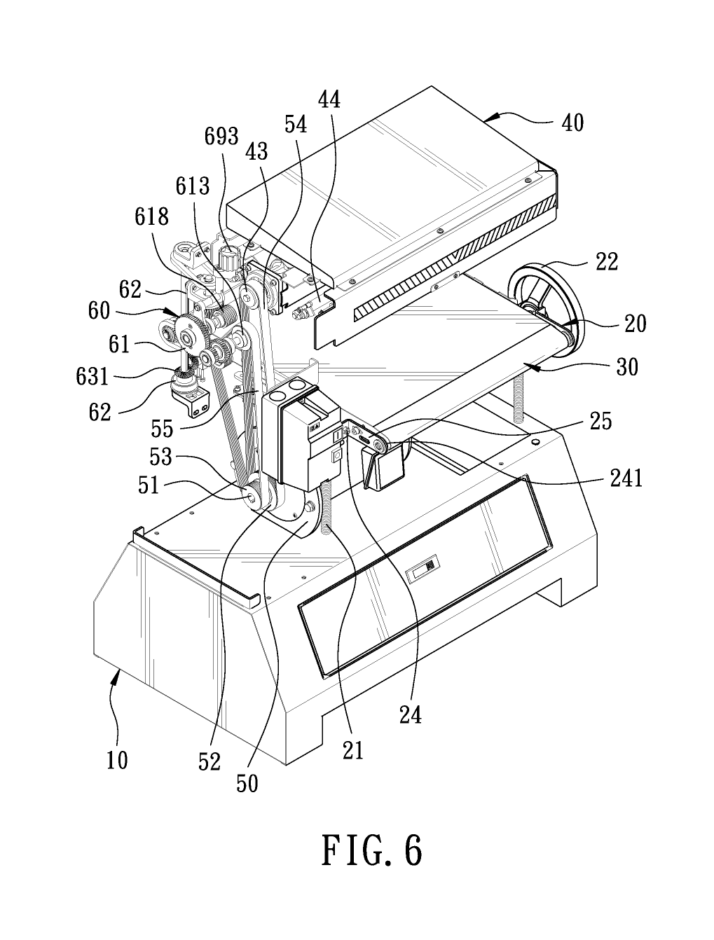

A preferred embodiment of a work piece feeding and conveying device for a planing machine 100 in the present invention, as shown in FIGS. 4, 5 and 6, includes an outer casing 101 covered around the planing machine 100, a foundation base 10, an intermediate base 20, a convey unit 30, an upper base 40, a motor 50 and a transmission unit 60 as main components combined together.

The foundation base 10 is a level stand on which the planing machine 100 can stably be positioned at any flat surface.

The intermediate base 20 assembled over the topside of the foundation base 10 has the four corners of its underside respectively secured with an adjusting threaded rod 21 for fixing the intermediate base 20 over the foundation base 10. One of the four adjusting threaded rods 21 has one side threadably connected with an adjusting rotary wheel 22 for adjusting height of the intermediate base 20 to maintain a proper planing distance between the intermediate base 20 and the upper base 40, and another one of the four adjusting threaded rods 21 has its upper end provided with a graduation rule 23. The intermediate base 20 has its opposite ends respectively and threadably combined with one end of a horizontal L-shaped adjusting block 25 by means of an adjusting member 24, and the adjusting block 25 has the other end bored with a through hole 241.

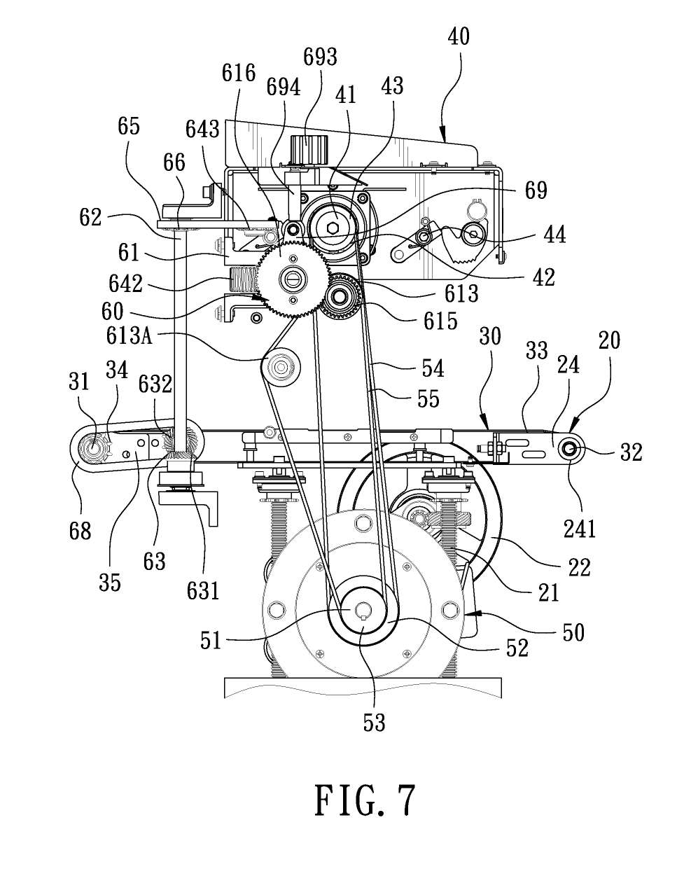

Referring to FIG. 7, the convey unit 30 is assembled on the intermediate base 20, composed of a front spindle 31, a rear spindle 32 and a conveyer belt 33. The front spindle 31 is fixedly inserted through the front end of the intermediate base 20, while the rear spindle 32 is firmly inserted through the rear end of the intermediate base 20, parallel to and separated from the front spindle 31 for a preset distance. The conveyer belt 33 formed with a rough outer surface with high friction coefficient is annularly fitted around the intermediate base 20 and diametrically passes through both the front spindle 31 and the rear spindle 32. The front spindle 31 has one end protruding outward and fixed thereon with a driven wheel 34 and its opposite sides respectively secured at the front end of the intermediate base 20 by a fixing plate 35. The rear spindle 32 has its opposite ends respectively inserted through the through hole 241 of the adjusting block 24 and secured with the adjusting block 24.

The upper base 40 is horizontally positioned over the convey unit 30 and has its center transversely and pivotally combined with a knife shaft 41 having its outer circumference pivotally combined with a plane knife 42 and having one end extending out of the upper base 40 and firmly fitted thereon with a rotary wheel 43. Further, the upper base 40 is pivotally disposed with a roller 44 at the front and the rear side of the plane knife 42.

The motor 50, as shown in FIG. 7, is installed on the flat topside of the foundation base 10 and positioned between the convey unit 30 and the foundation base 10, having one end provided with a driving shaft 51 axially extending outward and parallel to one side of the rotary wheel 43 fixed on the protruding end of the knife shaft 41. The driving shaft 51 is assembled thereon with a first driving wheel 52 and a second driving wheel 53, and the first driving wheel 52 has a diameter larger than the second driving wheel 53. A first transmission member 54 (a belt) and a second transmission member 55 (a belt) have their lower ends respectively pass around the outer circumference of the first driving wheel 52 and the second driving wheel 53, and the other end respectively go around the outer circumference of the rotary wheel 43 on the knife shaft 41 and around the transmission unit 60. Thus, the knife shaft 41 of the plane knife 42 and the transmission unit 60 are driven by the same motor 50 to rotate and respectively transmit different speeds to actuate the knife shaft 41 and the convey unit 30 to rotate.

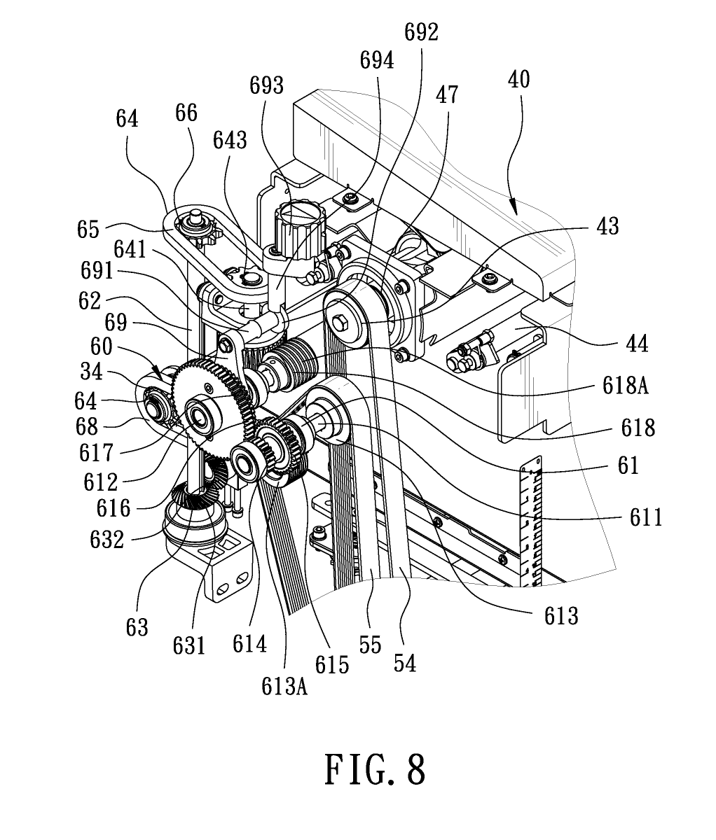

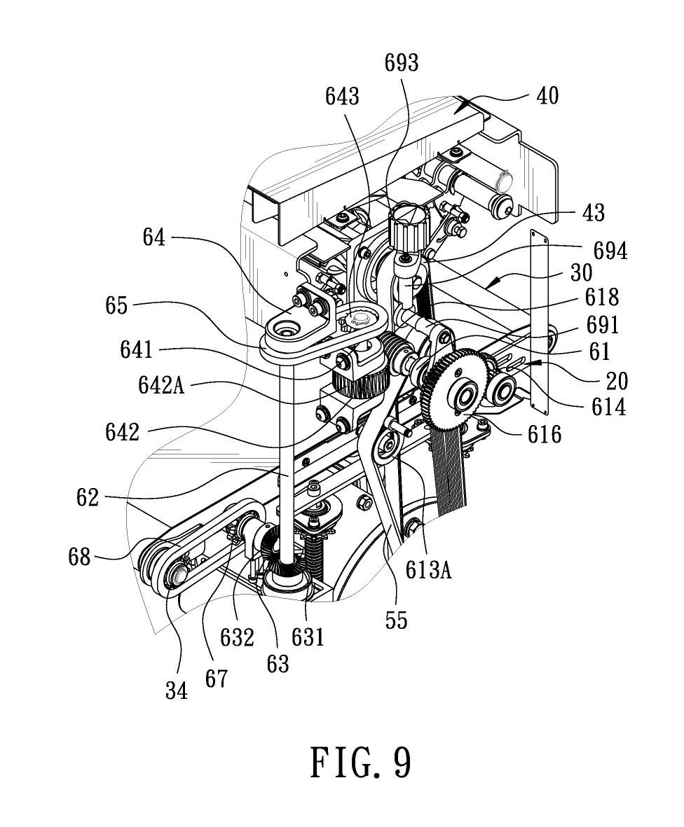

Referring to FIGS. 8 and 9, the transmission unit 60 is connected between the second transmission member 55 and the convey unit 30 for transmitting the power of the motor 50 to the convey unit 30, consisting of a first transmission set 61, a transmission shaft 62 and a second transmission set 63. The first transmission set 61 is fixed at one side of the upper base 40, parallel to one side of the driving shaft 51 and surrounded thereon with the upper end of the second transmission member 55 and also engaged with the upper end of the axial transmission shaft 62. The transmission shaft 62 has its lower end engaged with the second transmission set 63, which is to be connected with the driven wheel 34 of the front spindle 31 for actuating the convey unit 30 to rotate. The first transmission set 61 contains a first transmission rod 611 and a second transmission rod 612 parallel to each other and opposite to the upper end of the second driving wheel 53. The first transmission rod 611 has one end pivotally disposed with a first transmission wheel 613, and the second transmission member 55 goes around the first transmission wheel 613 and then passes around a guide wheel 613A disposed between the first transmission wheel 613 and the second driving wheel 53. The first transmission rod 611 has another end separately and pivotally mounted thereon with two different-sized gears 614, 615 to be engaged with one of two different-sized interacting gears 616, 617 fitted on one end of the second transmission rod 612. The second transmission rod 612 has another end firmly fitted with a worm 618 having its worm threads 618A formed diametrically and equidistantly to be engaged with a horizontal interacting set 64 and indirectly engaged with the upper end of the transmission shaft 62 via the interacting set 64. The interacting set 64 is axially provided with a shaft rod 641 adjacent and parallel to the transmission shaft 62 and having its lower end pivotally fitted with a worm wheel 642 having its worm threads 642A formed axially and equidistantly in parallel along the outer circumference of the shaft rod 641 and engaged with the worm threads 618A of the worm 618. The shaft rod 641 has its upper end firmly fitted with a first interacting wheel 643, and a horizontal third transmission member 65 (a belt) has one end passing around the interacting wheel 643 and another end passing around a second interacting wheel 66 pivotally fitted on the upper end of the transmission shaft 62. The second transmission set 63 includes a transmission sector gear 631 pivotally and slidably fitted at the lower end of the transmission shaft 62 and positioned opposite to the second interacting wheel 66 that is fitted at he upper end of the transmission shaft 62. The bevel gear 631 is engaged with a driven bevel gear 632 having its other side transversely protruding toward one side of the convey unit 30 and connected with a transmission wheel 67, and a fourth transmission member 68 (a belt) diametrically passes around both the transmission wheel 67 and the driven wheel 34 of the front spindle 31 for actuating the convey unit 30 to rotate diametrically. In addition, the second transmission rod 612 of the transmission set 61 is firmly fitted thereon with a triangular adjusting block 69 having an adjusting rod 691 horizontally inserted through its upper end. The adjusting rod 691 has its other end fitted with a circular adjusting block 692 having its upper end engaged with an adjusting support rod 694 at the lower end of a speed-change adjusting button 693, which is exposed out of the upper end of the upper base 40.

In order to further understand the structural features, the operational techniques and expected functions, how to use the invention is to be described below.

Referring to FIGS. 7, 8 and 9, when the planing machine 100 is to carry out planing, the adjusting rotary wheel 22 has to be turned first for adjusting the distance between the intermediate base 20 and the upper base 40, and during adjusting, the convey unit 30 will be moved upward and downward together with the intermediate base 20. Meanwhile, an accurate feeding depth for the plane knife 42 and the work piece placed on the convey unit 30 is adjusted by checking the graduation rule 23, and the transmission sector gear 631 of the transmission unit 60 is axially shifted on the transmission shaft 62. Next, start the motor 50 to drive the first driving wheel 52 and the second driving wheel 53 on the driving shaft 51 to rotate and respectively actuate the first transmission member 54 and the second transmission member 55 to turn around diametrically. Simultaneously, the first transmission member 54 will drive the rotary wheel 43 on the knife shaft 41 to rotate and actuate the plane knife 42 to rotate and carry out planing, while the second transmission member 55 will drive the first transmission wheel 613 of the transmission unit 60 to rotate and actuate the gears 614, 615 on the first transmission rod 611 to rotate and actuate the mutually engaged interacting gears 616, 617 to rotate. Synchronously, the worm 618 fitted on one end of the second transmission rod 612 will be actuated to turn the mutually engaged worm wheel 642 at the lower end of the shaft rod 641 of the interacting set 64 and in the meantime, the first interacting wheel 643 at the upper end of the shaft rod 641 will be driven to rotate and actuate the third transmission member 65 to turn and drive the second interacting wheel 66 to rotate and actuate the transmission shaft 62 together with the transmission sector gear 631 at its lower end to rotate. Meanwhile, the mutually engaged transmission sector gear 631 and the driven sector gear 632 will be rotated together to drive the transmission wheel 67 to rotate and actuate the fourth transmission member 68 on the transmission wheel 67 to turn diametrically and drive the driven wheel 34 to rotate and actuate the front spindle 31 to rotate and drive the conveyer belt 33 to operate. At this time, a work piece can be sent in from the front end of the intermediate base 20 to be conveyed toward the rear end of the intermediate base 20 by friction force produced on the rough surface of the conveyer belt 33, and the convey unit 30 will be actuated by the conveyer belt 33 to turn diametrically. Thus, both the knife shaft 41 of the plane knife 42 and transmission unit 60 can be driven by the same motor 50 to rotate and respectively transmit rotating speed to actuate the plane knife 42 and the convey unit 30 to rotate. Synchronously, the rollers 44 of the upper base 40 will be actuated by the work piece to rotate and press the work piece on the conveyer belt 33 to better flatness and smoothness of the planed surface of the work piece. In addition, the rotating speed of the convey unit 30 can be adjusted by turning the speed-change adjusting button 693 to actuate the adjusting support rod 694 to adjust the second transmission rod 612 of the transmission set 61 to shift to let the interacting gear 616, 617 on the second transmission rod 612 engaged with one of the two gears 614, 615 of the first transmission rod 611, thus achieving effect of speed changing. Further, the tightness of the conveyer belt 33 can be adjusted by unscrewing the adjusting member 24 and then moving the adjusting block 25 to adjust the distance between the rear spindle 32 and the intermediate base 20. Furthermore, when the planing machine 100 is carrying out planning work, the adjusting rotary wheel 22 can simultaneously be turned to adjust the distance between the intermediate base 20 and the upper base 40 for timely adjusting an accurate feeding depth for the work piece.

While the preferred embodiment of the invention has been described above, it will be recognized and understood that various modifications may be made therein and the appended claims are intended to cover all such modifications that may fall within the spirit and scope of the invention.

I claim:

1. A work piece feeding and conveying device for a planing machine comprising a foundation base, an intermediate base and an upper base, which are orderly assembled over said foundation base, said intermediate base disposed thereon with a convey unit, and said upper base pivotally provided with a plane knife, a knife shaft of said plane knife and said convey unit driven by a same motor to rotate respectively; and
characterized by said motor installed between said convey unit and said foundation base and having its driving shaft assembled thereon with a first driving wheel and a second driving wheel, a first transmission member and a second transmission member respectively having one end passing around said first driving wheel and said second driving wheel, said first transmission member having another end passing around said knife shaft, said second transmission member having another end passing around said convey unit.

2. The work piece feeding and conveying device for a planing machine as claimed in claim 1, wherein said first transmission member and said second transmission member are respectively a belt.

3. The work piece feeding and conveying device for a planing machine as claimed in claim 1, wherein said planing machine has one side installed with a transmission unit at a preset location, said transmission unit connected between said second transmission member and said convey unit, said transmission unit composed of a first transmission set, a transmission shaft and a second transmission set, said first transmission set secured at one side of said first transmission set secured at one side of said upper base, said second transmission member having another end passing around said first transmission set, said first transmission set engaged with an upper end of said transmission shaft disposed axially, said transmission shaft having its lower end engaged with said second transmission set, said second transmission set connected with said convey unit for actuating said convey unit to rotate.

4. The work piece feeding and conveying device for a planing machine as claimed in claim 3, wherein said first transmission set consists of a first transmission rod and a second transmission rod parallel to each other and opposite to an upper end of said second driving wheel, said first transmission rod having one end pivotally provided with a first transmission wheel, said second transmission member having another end passing around said first transmission wheel, said second transmission member also passing around a guide wheel positioned between said first transmission wheel and said second driving wheel, said first transmission rod having another end separately and pivotally disposed with two different-sized gears to be engaged with one of two different-sized interacting gears that are fitted at one end of said second transmission rod, said second transmission rod having another end firmly fitted thereon with a worm having its worm threads formed diametrically and equidistantly, said worm engaged with a horizontal interacting set and indirectly engaged with an upper end of said transmission shaft by means of said interacting set.

5. The work piece feeding and conveying device for a planing machine as claimed in claim 4, wherein said interacting set is axially fitted with a vertical shaft rod adjacent and parallel to said transmission shaft, said shaft rod having its lower end pivotally disposed with a worm wheel having its worm threads formed axially and equidistantly in parallel and engaged with said worm threads of said worm, said shaft rod having its upper end pivotally assembled with a first interacting wheel, a third transmission member passing around both said first interacting wheel and a second interacting wheel pivotally fitted at an upper end of said transmission shaft, said transmission shaft driven to rotate by said interacting set.

6. The work piece feeding and conveying device for a planing machine as claimed in claim 5, wherein said third transmission member is a belt.

7. The work piece feeding and conveying device for a planing machine as claimed in claim 3, wherein said second transmission set contains a bevel gear pivotally and slidably fitted at a lower end of said transmission shaft and engaged with a driven bevel gear, said driven sector gear having another side extending outward and connected with a transmission wheel, a fourth transmission member passing around both said transmission wheel and said convey unit for actuating said convey unit to rotate.

8. The work piece feeding and conveying device for a planing machine as claimed in claim 7, wherein said fourth transmission member is a belt.

9. The work piece feeding and conveying device for a planing machine as claimed in claim 1, wherein said intermediate base has its four circumferential sides respectively locked with an adjusting threaded rod to fixedly position said intermediate base over said foundation base, and an adjusting rotary wheel is provided at one side of one said adjusting threaded rod for adjusting a feeding distance between said intermediate base and said upper base.

10. The work piece feeding and conveying device for a planing machine as claimed in claim 4, wherein said second transmission rod is firmly fitted thereon with an adjusting block having another end inserted therethrough with an adjusting rod, said adjusting rod having another end fitted with an circular adjusting block, said circular adjusting block having its upper end engaged with an adjusting support rod at a lower end of a speed-change adjusting button, said speed-change adjusting button exposed out of an upper end of said upper base.
